(19) United States
(12) Patent Application Publication
(10) Pub. No.: US 2021/0388790 A1
(43) Pub. Date: Dec. 16, 2021

(54) Control Device for Vehicle Fuel Injection Control Method for Vehicle and Fuel Injection Control Program for Vehicle

(71) Applicant: Hitachi Astemo, Ltd., Hitachinaka-shi, Ibaraki (JP)

(72) Inventors: Ryo KUSAKABE, Tokyo (JP); Yoshihiro SUKEGAWA, Tokyo (JP); Masayuki SARUWATARI, Hitachinaka-shi (JP)

(21) Appl. No.: 17/291,067

(22) PCT Filed: Oct. 11, 2019
(86) PCT No.: PCT/JP2019/040165

§ 371 Date: May 4, 2021

(30) Foreign Application Priority Data
Nov. 6, 2018 (JP) 2018-208664

(51) Int. Cl. F02D 41/20; F02M 51/06; F02M 61/18; F02D 41/40

(52) U.S. Cl. CPC F02D 41/20; F02M 51/061; F02M 61/1886; F02D 2200/0614; F02D 41/402; F02D 2041/2051; F02D 2200/0602; F02D 41/401

(57) ABSTRACT

A shot variation in injection quantity of a fuel injection device is reduced. A control device according to an aspect of the present invention performs a first current control for a solenoid by a first current waveform by applying a reverse voltage to the solenoid before a mover or a valve collides with a fixed portion, when an injection quantity of a fuel from opening to closing of the valve of the fuel injection device is a set value or more. In addition, the control device performs a second current control for the solenoid by a second current waveform so that a current larger than a holding current holding the mover or the valve in a state of being in contact with the fixed portion flows to the solenoid, until the mover or the valve collides with the fixed portion, when the injection quantity of the fuel from opening to closing of the valve is less than the set value.

### TECHNICAL FIELD

The present invention relates to a control device for a vehicle for driving a fuel injection device of an internal combustion engine, a fuel injection control method for a vehicle, and a fuel injection control program for a vehicle.

### BACKGROUND ART

Recently, from the viewpoint of stricter regulations for exhaust gas or protection of the environment, in an engine, lean combustion in which a fuel is combusted in a state where it is leaner than that in a theoretical air-fuel ratio has been required. In the lean combustion, a speed of combustion becomes slow and combustion becomes unstable because the fuel is in the lean state, and thus, a pressure in an engine cylinder varies for each cycle, which may be a limit of the lean combustion. Therefore, in the lean combustion, it is required to suppress a variation in each injection of the fuel to be injected (injection quantity) from a fuel injection device in order to suppress the variation for each cycle.

In general, the injection quantity of the fuel injection device is controlled by a pulse width of an injection pulse output from an engine control unit (ECU). A normally closed valve type electromagnetic fuel injection device includes biasing means for generating a force in a valve-closing direction and a drive unit including a solenoid, a fixed core, and a mover. A current is supplied to the solenoid in the drive unit, such that a magnetic attraction force is generated between the fixed core and the mover, and the mover moves in a valve-opening direction at a point in time when the magnetic attraction force exceeds a biasing force in the valve-closing direction. Then, the valve is separated from a valve seat and starts to be opened at a timing when the mover collides with the valve. Thereafter, when the current supply to the solenoid is stopped, the magnetic attraction force generated between the fixed core and the mover is reduced, and the valve starts to be closed at a point in time when the magnetic attraction force becomes smaller than the biasing force in the valve-closing direction.

In addition, in general, in order to quickly shift from a valve-closed state to a valve-opened state, a drive circuit of the electromagnetic fuel injection device first applies a high voltage from a high voltage source to the solenoid when the injection pulse is output from the ECU, and then performs a control to rapidly raise the current of the solenoid. Thereafter, the valve is separated from the valve seat and moves toward the fixed core. Then, the drive circuit controls switching so that a constant current is supplied to the solenoid by switching an applied voltage to a low voltage.

Since the injection quantity of the fuel injection device is determined by an integral value of displacement amounts of the valve, it is required to keep the movement of the valve for each shot at the same level in order to suppress a variation for each injection (shot variation).

For example, as a control method of suppressing a variation in injection quantity, there is a method disclosed in PTL 1. PTL 1 discloses a method of selecting a reference fuel injection valve from a plurality of fuel injection valves based on information on a valve-opening response delay time and/or a valve-closing response delay time for each fuel injection valve and correcting drive pulse widths of the other fuel injection valves to match each of injection quantities of the other fuel injection valves to an injection quantity of the selected fuel injection valve.

### CITATION LIST

### Patent Literature

PTL 1: WO 2015/004988 A

### SUMMARY OF INVENTION

### Technical Problem

An object of the technique disclosed in PTL 1 is to correct a drive pulse width for each fuel injection valve for supplying a fuel to each cylinder and to suppress a relative variation in injection quantity supplied to each cylinder. However, in the technique disclosed in PTL 1, it is not mentioned that a shot variation in injection quantity of the fuel injection valve (valve) is reduced.

The present invention has been made in view of these circumstances, and an object of the present invention is to suppress a variation in displacement of a valve for each shot and to reduce a shot variation in injection quantity.

### Solution to Problem

A control device for a vehicle according to an aspect of the present invention controls a fuel injection device including a valve which comes into contact with and is separated from a valve seat, a mover which drives the valve, a solenoid which generates a magnetic attraction force for attracting the mover to form a space for introducing a fuel between the valve seat and the valve, and a fixed core which attracts the mover by the magnetic attraction force. The control device for a vehicle includes a control unit that performs a control of a current supplied to the solenoid.

The control unit performs a first current control for the solenoid by a first current waveform by switching a polarity of a voltage applied to the solenoid before the mover or the valve collides with a fixed portion to a polarity reverse to the polarity of the voltage applied before the mover or the valve collides with the fixed portion, when an injection quantity of the fuel injected until the valve comes into contact with the valve seat again after the valve is separated from the valve seat is a set value or more.

In addition, the control unit performs a second current control for the solenoid by a second current waveform so that a current larger than a holding current holding the mover or the valve in a state of being in contact with the fixed portion flows to the solenoid, until the mover or the valve collides with the fixed portion, when the injection quantity of the fuel injected until the valve comes into contact with the valve seat again after the valve is separated from the valve seat is less than the set value.

### Advantageous Effects of Invention

According to the present invention, in a range from a small injection quantity to a large injection quantity, it is possible to suppress a variation in displacement of the valve for each shot and to reduce a shot variation in injection quantity.

Objects, configurations, and effects other than those described above will become apparent from the following description of embodiments.

### BRIEF DESCRIPTION OF DRAWINGS

FIG. 1 is a schematic view illustrating an example of a fuel injection system including a fuel injection device and a control device according to a first embodiment of the present invention.

FIG. 2 is a view illustrating an example of a longitudinal section of the fuel injection device according to the first embodiment of the present invention and is a view illustrating a configuration example of a drive circuit and an engine control unit (ECU) connected to the fuel injection device.

FIG. 3 is an enlarged cross-sectional view illustrating an example of a structure of a drive unit of the fuel injection device according to the first embodiment of the present invention.

FIG. 4 is a timing chart showing a relationship between a general injection pulse for driving the fuel injection device, a drive voltage and a drive current supplied to the fuel injection device, and displacement amounts of a valve and a mover, and a time.

FIG. 5 is a circuit diagram illustrating an example of the drive circuit and the ECU of the fuel injection device.

FIG. 6 is a timing chart showing a relationship between the injection pulse, the drive current supplied to the fuel injection device, an operation timing of a switching element of the fuel injection device, a voltage across terminals of a solenoid, and displacement amounts of the valves and the mover, and a time, according to the first embodiment of the present invention.

FIG. 7 is a diagram showing a relationship between an injection quantity when the fuel injection device is controlled by the drive current waveform of FIG. 6 and a standard deviation (σ) of a shot variation in injection quantity, and an injection pulse width.

FIG. 8 is a diagram showing a relationship between a voltage across terminals of a solenoid and a drive current supplied to a fuel injection device, and a time, according to a first modification of the first embodiment of the present invention.

FIG. 9 is a diagram showing a relationship between a drive current supplied to a fuel injection device and a displacement amount of a valve, and a time, according to a second embodiment of the present invention.

FIG. 10 is a diagram showing an injection timing and an injection period of each of an intake stroke and a compression stroke according to a third embodiment of the present invention.

FIG. 11 is a diagram showing an injection timing and an injection period of each of an intake stroke and a compression stroke according to a fourth embodiment of the present invention.

FIG. 12 is a diagram showing a relationship between an injection quantity and a standard deviation (σ) of a shot variation in injection quantity, and an injection pulse width, according to a fifth embodiment of the present invention.

### DESCRIPTION OF EMBODIMENTS

Hereinafter, examples of modes for implementing the present invention (hereinafter, referred to as “embodiments”) will be described with reference to the accompanying drawings. In the present specification and the accompanying drawings, constituent elements having substantially the same functions or configurations are assigned with the same reference numerals and redundant description thereof is omitted.

### First Embodiment

### Configuration of Fuel Injection System

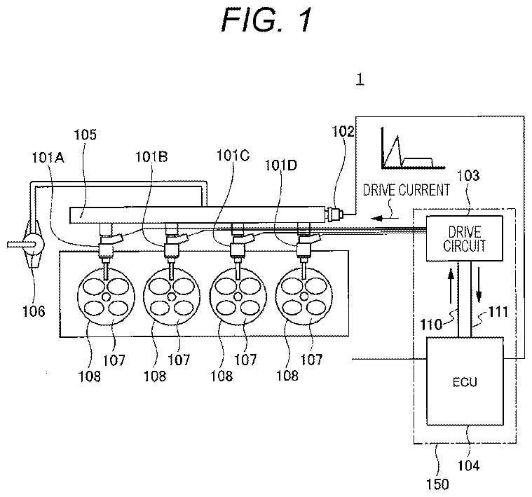

Hereinafter, a configuration of a fuel injection system according to a first embodiment of the present invention will be described with reference to FIGS. 1 to 7.

First, an outline of a fuel injection system according to the first embodiment will be described with reference to FIG. 1. FIG. 1 illustrates a configuration example of a fuel injection system 1 according to the first embodiment. The fuel injection system 1 is an example in which the present invention is applied to an in-cylinder direct injection type engine (an example of an internal combustion engine), but the present invention is not limited to this example. In the present specification, the in-cylinder direct injection type engine is simply referred to as an “engine”.

As illustrated in FIG. 1, the fuel injection system 1 includes four fuel injection devices 101A to 101D and a control device 150. The in-cylinder direct injection type engine according to the present embodiment includes four cylinders 108 (engine cylinders). The control device 150 is, for example, a control device for a vehicle for controlling the fuel injection devices 101. In the following description, in a case where the fuel injection devices 101A to 101D are not distinguished, the fuel injection devices 101A to 101D are referred to as the “fuel injection devices 101”.

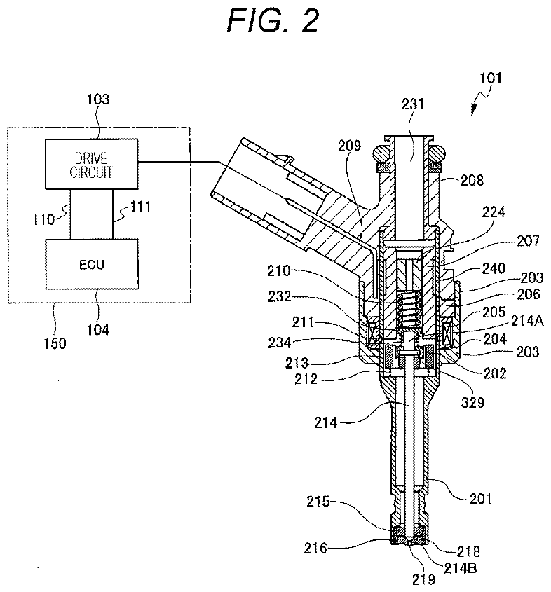

The fuel injection devices 101A to 101D are installed in the cylinders 108 of the fuel injection system 1, respectively, so that an air-fuel is directly injected into combustion chambers 107 from an injection hole 219 (see FIG. 2 described below) of the fuel injection device. The fuel is sent to a fuel pipe 105 after being pressurized by a fuel pump 106, and the fuel is delivered to the fuel injection devices 101A to 101D through the fuel pipe 105. A pressure sensor 102 for measuring a fuel pressure in the fuel pipe 105 is installed at one end of the fuel pipe 105. The fuel pressure varies according to a balance between a flow rate of the fuel discharged by the fuel pump 106 and an injection quantity of the fuel injected into each of the fuel chambers 107 by the fuel injection devices 101. The amount of fuel discharged from the fuel pump 106 is controlled at a predetermined pressure as a target value based on a measurement result of the pressure sensor 102.

The fuel injection of each of the fuel injection devices 101A to 101D is controlled by a pulse width of an injection pulse sent from an engine control unit (ECU) 104 (hereinafter, referred to as an “injection pulse width”). That is, an injection quantity of the fuel injected is determined based on the injection pulse width supplied to the fuel injection devices 101. A command of the injection pulse width is input to a drive circuit 103 provided for each fuel injection device 101. The drive circuit 103 determines a waveform of a drive current based on a command from the ECU 104 (abbreviated as a “current” sometimes) and supplies the drive current of the waveform to the fuel injection device 101 for a time based on the injection pulse width. Note that the drive circuit 103 may be mounted as a component or a substrate integrated with the ECU 104. In the present embodiment, a device in which the drive circuit 103 and the ECU 104 are integrated is referred to as the control device 150.

Next, a configuration and a basic operation of each of the fuel injection device 101 and the control device 150 will be described. FIG. 2 illustrates an example of a longitudinal section of the fuel injection device 101 and a configuration example of the drive circuit 103 and the ECU 104 connected to the fuel injection device 101.

In the ECU 104, signals indicating a state of the engine are received from various types of sensors (not illustrated), and the injection pulse width or the injection timing are calculated to control the injection quantity of the fuel injected from the fuel injection device 101 according to an operation condition of the internal combustion engine. In addition, the ECU 104 is provided with an A/D converter and an I/O port to receive the signals from various types of sensors. The injection pulse output from the ECU 104 is input to the drive circuit 103 through a signal line 110. The drive circuit 103 controls a voltage to be applied to a solenoid (coil) 205 and supplies a current. The ECU 104 communicates with the drive circuit 103 through a communication line 111. The ECU 104 can switch the drive current generated by the drive circuit 103 according to the pressure of the fuel to be supplied to the fuel injection device 101 and the operation condition, or can change set values of the current and a time, through the communication line 111.

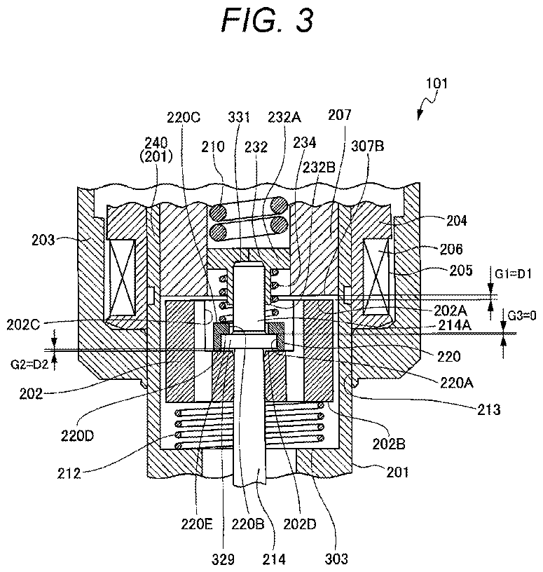

Next, the configuration and the operation of the fuel injection device 101 will be described with reference to the longitudinal section of the fuel injection device 101 of FIG. 2 and FIG. 3. FIG. 3 is an enlarged cross-sectional view illustrating an example of a structure of a drive unit of the fuel injection device 101. In particular, a relationship between a mover 202, a valve 214, and a fixed core 207 will be described.

The fuel injection device 101 illustrated in FIGS. 2 and 3 is an electromagnetic fuel injection device provided with a normally closed valve type electromagnetic valve. A substantially rod-like valve 214 is included inside the fuel injection device 101. An orifice cup 216 in which a valve seat 218 is formed is provided at a position opposite to a distal end of the valve 214. The injection hole 219 for injecting the fuel is formed in the valve seat 218. A spring (hereinafter, referred to as a “first spring”) 210 biasing the valve 214 in a valve-closing direction (downward direction) is provided on an upper portion of the valve 214. When the solenoid 205 is energized, a magnetic attraction force acts on the mover 202 to move the mover 202, and the valve 214 moves in conjunction with the mover 202. When the solenoid 205 is de-energized, the valve 214 is biased by the first spring 210 in the valve-closing direction, the valve 214 comes into contact with the valve seat 218, and the fuel is sealed (valve-closed state).

A concave portion 202C is formed in an upper end surface 202A of the mover 202 toward a lower end surface 202B of the mover 202. An intermediate member 220 is provided inside the concave portion 202C. The intermediate member 220 is a member positioned at the intermediate between the mover 202 and the fixed core 207. A concave portion 220A is formed upward in a lower surface of the intermediate member 220. The concave portion 220A is formed to have a diameter (inner diameter) and a depth so that a stepped portion 329 (flange portion) formed in an annular shape on an outer circumferential surface of a head portion 214A is fitted into the concave portion 220A. That is, the diameter (inner diameter) of the concave portion 220A is larger than a diameter (outer diameter) of the stepped portion 329, and a depth dimension of the concave portion 220A is larger than a dimension between an upper end surface and a lower end surface of the stepped portion 329. A through-hole 220B through which a projection 331 of the head portion 214A penetrates is formed at a bottom (bottom surface 220E) of the concave portion 220A.

A spring (hereinafter, referred to as a “third spring”) 234 is held between the intermediate member 220 and a cap 232. A spring seat against which one end of the third spring 234 abuts is formed on an upper end surface 220C of the intermediate member 220. The third spring 234 biases the mover 202 in the valve-closing direction from the fixed core 207.

The lid-like cap 232 is disposed above the intermediate member 220. A flange portion 232A which protrudes in a radial direction is formed at an upper end portion of the cap 232, and a spring seat against which the other end of the third spring 234 abuts is formed on a lower end surface of the flange portion 232A. A cylindrical portion 232B is formed downward on the lower end surface of the flange portion 232A of the cap 232, and an upper portion (head portion 214a) of the valve 214 is press-fitted and fixed into the cylindrical portion 232B.

As such, the cap 232 and the intermediate member 220 form the spring seat of the third spring 234. Therefore, a diameter (inner diameter) of the through-hole 220B of the intermediate member 220 is smaller than a diameter (outer diameter) of the flange portion 232A of the cap 232. In addition, a diameter (outer diameter) of the cylindrical portion 232B of the cap 232 is smaller than an inner diameter of the third spring 234.

The cap 232 receives a biasing force of the first spring 210 from above and receives a biasing force (set load) of the third spring 234 from below. The biasing force of the first spring 210 is larger than the biasing force of the third spring 234. As a result, the cap 232 is pressed to the projection 331 formed on the upper portion of the valve 214 by a difference between the biasing force of the first spring 210 and the biasing force of the third spring 234. A force in a direction (the downward direction in the drawing) in which the valve 214 comes out from the projection 331 of the valve 214 is not applied to the cap 232. However, the cap 232 may be only press-fitted and fixed to the projection 331 without being welded.

In addition, it is required to provide a gap to some degree between the lower end surface of the flange portion 232A of the cap 232 and the upper end surface 220C of the intermediate member 220 in order to dispose the third spring 234. Therefore, a length of the cylindrical portion 232B of the cap 232 is easily secured.

The intermediate member 220 will be described again. A state of the fuel injection device 101 illustrated in FIG. 2 is a state where the valve 214 receives the biasing force generated by the first spring 210 and the magnetic attraction force does not act on the mover 202. In this state, a distal end 214B (seat portion) of the valve 214 abuts against the valve seat 218, and thus, the fuel injection device 101 is in the valve-closed and stable state.

In the valve-closed state, the intermediate member 220 receives the biasing force of the third spring 234, and a bottom surface 220E of the concave portion 220A formed in the intermediate member 220 abuts against the upper end surface of the stepped portion 329 of the valve 214. That is, a size (dimension) of a gap G3 between the bottom surface 220E of the concave portion 220A formed in the intermediate member 220 and the upper end surface of the stepped portion 329 of the valve 214 is zero. The bottom surface 220E of the concave portion 220A formed in the intermediate member 220 and the upper end surface of the stepped portion 329 of the valve 214 form an abutting surface where the intermediate member 220 abuts against the valve 214.

A zero spring (hereinafter, referred to as a “second spring”) 212 is disposed between the lower end surface 202B of the mover 202 and an abutting surface 303 formed inside a nozzle holder 201 (large diameter cylindrical portion 240). Since the mover 202 receives a biasing force of the second spring 212 and then is biased toward the fixed core 207, a bottom surface 202D of the concave portion 202C formed in the mover 202 abuts against a lower end surface 220D of the intermediate member 220. The biasing force of the second spring 212 is smaller than the biasing force of the third spring 234. Therefore, the mover 202 is not possible to push back the intermediate member 220 biased downwardly by the third spring 234, and thus, the movement of the mover 202 in an upward direction (valve-opening direction) is stopped by the intermediate member 220 and the third spring 234.

The depth dimension of the concave portion 220A of the intermediate member 220 is larger than a height (dimension between the upper end surface and the lower end surface) of the stepped portion 329 of the valve 214. Therefore, in the state (valve-closed state) illustrated in FIG. 3, the bottom surface 202D of the concave portion 202C formed in the mover 202 does not abut against the lower end surface of the stepped portion 329 of the valve 214, and a gap G2 having a size (dimension) of D2 is formed between the bottom surface 202D of the concave portion 202C and the lower end surface of the stepped portion 329. The size D2 of the gap G2 is smaller than a size (dimension) D1 of a gap G1 formed between the upper end surface 202A (surface facing the fixed core 207) of the mover 202 and a lower end surface 207B (surface facing the mover 202) of the fixed core 207 (D2<D1). As described herein, the intermediate member 220 is a member to form the gap G2 having the size of D2 between the mover 202 and the lower end surface of the stepped portion 329 of the valve 214, and the intermediate member 220 may also be referred to as a gap forming member.

The third spring 234 biases the intermediate member (gap forming member) 220 in the valve-closing direction (downward direction), and the intermediate member 220 in the valve-closed state of FIG. 3 serves as the upper end surface (reference position) of the stepped portion 329 of the valve 214. In this state, the lower end surface 220D of the intermediate member 220 abuts against the mover 202, such that the gap G2 having the size D2 is formed between the lower end surface of the stepped portion 329 which is an engagement portion of the valve 214 and the bottom surface 202D of the concave portion 202C which is an engagement portion of the mover 202. The bottom surface 220E of the concave portion 220A abuts against the upper end surface (reference position) of the stepped portion 329 of the valve 214, such that the intermediate member 220 serves as the upper end surface of the stepped portion 329.

Here, the biasing forces of the three springs described above will be described again. Among the first spring 210, the second spring 212, and the third spring 234, the spring force (biasing force) of the first spring 210 is the largest. The spring force (biasing force) of the third spring 234 is next, and the spring force (biasing force) of the second spring 212 is the smallest.

In the present embodiment, the diameter of the through-hole formed in the mover 202 is smaller than the diameter of the stepped portion 329 of the valve 214. Therefore, in the valve 214, at the time of a valve-opening operation of shifting from the valve-closed state to the valve-opened state or at the time of a valve-closing operation of shifting from the valve-opened state to the valve-closed state, the lower end surface of the stepped portion 329 of the valve 214 engages with the bottom surface 202D of the concave portion 202C formed in the mover 202, and the mover 202 moves in cooperation with the valve 214. However, in a case where a force that moves the valve 214 upwardly or a force that moves the mover 202 downwardly independently acts, the valve 214 and the mover 202 can move in separate directions. The operation of each of the mover 202 and the valve 214 will be described in detail below.

In the present embodiment, an outer circumferential surface of the mover 202 is in contact with an inner circumferential surface of the nozzle holder 201 (housing member), such that the movement of the mover 202 is guided in a vertical direction (valve-opening direction and valve-closing direction). Further, an outer circumferential surface of the valve 214 is in contact with an inner circumferential surface of the through-hole of the mover 202, such that the movement of the valve 214 is guided in the vertical direction (valve-opening direction and valve-closing direction). That is, an inner circumferential surface of the nozzle holder 201 functions as a guide when the mover 202 moves in an axial direction. In addition, an inner circumferential surface of the through-hole of the mover 202 functions as a guide when the valve 214 moves in the axial direction. The distal end 214B of the valve 214 is guided by a guide hole of an annular guide member 215. The valve 214 is guided by the inner circumferential surface of the nozzle holder 201, the through-hole of the mover 202, and the guide member 215 to straightly reciprocate in the axial direction.

Note that, in the present embodiment, the fact that the upper end surface 202A of the mover 202 abuts against the lower end surface 207B of the fixed core 207 has been described, but the present invention is not limited to this example. A projection may be provided on one or both of the upper end surface 202A of the mover 202 and the lower end surface 207B of the fixed core 207, so that the projection and the end surface or the projections may abut against each other. In this case, the above-described gap G1 becomes a gap between an abutting portion close to the mover 202 and an abutting portion close to the fixed core 207.

The description will be returned back to FIG. 2. The fixed core 207 is press-fitted into an inner circumferential portion of the large diameter cylindrical portion 240 of the nozzle holder 201, and both the members are welded and joined at a press-fit contact position. The fixed core 207 is a component which allows the magnetic attraction force to act on the mover 202 and attracts the mover 202 in the valve-opening direction. A gap formed between an inner portion of the large diameter cylindrical portion 240 of the nozzle holder 201 and the ambient air is sealed by welding and joining of the fixed core 207. The fixed core 207 is provided with a through-hole (central hole) having a diameter slightly larger than the diameter of the intermediate member 220 as a fuel passage in its center. The head portion 214A of the valve 214 and the cap 232 are inserted into an inner circumference of a lower end portion of the through-hole of the fixed core 207 in a non-contact state.

A lower end of the first spring 210 for setting an initial load abuts against a spring receiving surface formed on the upper end surface of the cap 232 provided near the head portion 214A of the valve 214. The upper end of the first spring 210 is received by an adjustment pin 224 (see FIG. 1) to be press-fitted into the inner portion of the through-hole of the fixed core 207, such that the first spring 210 is held between the cap 232 and the adjustment pin 224. A fixed portion of the adjustment pin 224 is adjusted, such that an initial load in which the first spring 210 can press the valve 214 against the valve seat 218 can be adjusted.

In a state where the initial load of the first spring 210 is adjusted, the lower end surface 207B of the fixed core 207 is configured to face the upper end surface 202A of the mover 202 with a magnetic attraction gap (gap G1) of about 40 to 100 μm between the lower end surface 207B of the fixed core 207 and the upper end surface 202A of the mover 202. Note that each of the constituent elements is enlarged in FIG. 2 without regard for a dimensional ratio thereof.

In addition, a cup-shaped housing 203 is fixed to an outer circumference of the large diameter cylindrical portion 240 of the nozzle holder 201. A through-hole 213 is provided in the center of a bottom of the housing 203, and the large diameter cylindrical portion 240 of the nozzle holder 201 is inserted into the through-hole 213. A portion of an outer circumferential wall of the housing 203 forms an outer circumferential yoke portion which faces the outer circumferential surface of the large diameter cylindrical portion 240 of the nozzle holder 201. The annular or cylindrical solenoid 205 is disposed in an annular space formed between the housing 203 and the large diameter cylindrical portion 240.

The solenoid 205 is formed of an annular bobbin 204 which is opened outwardly in a radial direction and has a groove having a U-shaped section and a copper wire 206 wound around the groove. A rigid conductor 209 is fixed to ends of winding start and winding end of the solenoid 205. The conductor 209, the fixed core 207, and the outer circumference of the large diameter cylindrical portion 240 of the nozzle holder 201 are molded by injecting an insulating resin from an inner circumference of an upper end opening of the housing 203 to be covered with a resin molded body. An annular magnetic passage is formed in the fixed core 207, the mover 202, the large diameter cylindrical portion 240 of the nozzle holder 201, and the housing (outer circumferential yoke portion) 203 to surround the solenoid 205.

The fuel supplied to the fuel injection device 101 is supplied from the fuel pipe 105 provided on the upstream of the fuel injection device 101 and flows to the distal end of the valve 214 through a first fuel passage hole 231. The fuel is sealed by the seat portion formed at the end of the valve seat 218 of the valve 214 and the valve seat 218. In the valve-closed state, a differential pressure is generated between the upper portion and the lower portion of the valve 214 by a fuel pressure, and the valve 214 is pressed in the valve-closing direction by the fuel pressure and a force according to a pressure receiving area of an inner diameter of the seat portion at a valve seat position. In addition, in the valve-closed state, the gap G2 is formed between the abutting surface of the valve 214 and the mover 202 (the lower end surface of the stepped portion 329 and the bottom surface 202D of the concave portion 202C) and the intermediate member 220. As such, the mover 202 and the valve 214 are disposed with the gap G2 formed therebetween in the axial direction in a state where the valve 214 is seated in the valve seat 218.

The operation of the fuel injection device 101 configured as described above will be described. When the current is supplied to the solenoid 205, a magnetic flux passes between the fixed core 207 and the mover 202 by a magnetic field generated by a magnetic circuit, and the magnetic attraction force acts on the mover 202. The mover 202 starts to be displaced in a direction of the fixed core 207 at a timing when the magnetic attraction force acting on the mover 202 exceeds a load of the third spring 234. At this time, since the valve 214 comes into contact with the valve seat 218, the mover 202 moves in a state where the fuel does not flow. Since the movement of the mover 202 is an idling movement performed separately from the valve 214 that receives the differential pressure by the fuel pressure. Therefore, the mover 202 can move at a high speed without being affected by the fuel pressure and the like.

In addition, even in a case where the fuel pressure in the cylinder 108 is increased, it is required to set a strong load of the first spring 210 in order to suppress the injection of the fuel. That is, the load of the first spring 210 does not act on the valve 214 in the valve-closed state, such that the valve 214 can move at a high speed.

When a displacement amount of the mover 202 reaches the size of the gap G2, the mover 202 transmits a force to the valve 214 through the abutting surface (the bottom surface 202D of the concave portion 202C) to pull up the valve 214 in the valve-opening direction. In this case, the mover 202 moves idly and collides with the valve 214 while having kinetic energy. Therefore, the valve 214 receives the kinetic energy of the mover 202 and starts to be displaced in the valve-opening direction at a high speed.

A differential pressure generated according to the fuel pressure acts on the valve 214. The differential pressure acting on the valve 214 is generated due to a decrease in pressure of the fuel near the distal end 214B of the valve 214 according to a decrease in pressure generated by a decrease in static pressure caused by a Bernoulli effect after the flow rate of the fuel at the seat portion is increased in a range in which a passage cross-sectional area in the vicinity of the seat portion of the valve 214 is small.

As such, the differential pressure acting on the valve 214 is largely influenced by the passage cross-sectional area in the vicinity of the seat portion. Therefore, the differential pressure is increased under a condition in which the displacement amount of the valve 214 is small, and the differential pressure is decreased under a condition in which the displacement amount is large. Therefore, the valve 214 is opened with conflict due to the idle movement of the mover 202 at a timing when the valve 214 starts to be opened from the valve-closed state, the displacement becomes small, and it becomes difficult to perform the valve-opening operation due to a large differential pressure. Therefore, the valve-opening operation of the fuel injection device 101 can be performed even in a state where a higher fuel pressure acts. In addition, it is possible to set the biasing force of the first spring 210 to a stronger force in a fuel pressure range required for the valve-opening operation. The first spring 210 is set to have a stronger force, such that a time required for a valve-closing operation to be described below can be shortened and a minute injection quantity can thus be effectively controlled.

After the valve 214 starts the valve-opening operation, the mover 202 collides with the fixed core 207. At the time when the mover 202 collides with the fixed core 207, the mover 202 rebounds, but the mover 202 is attracted to the fixed core 207 by the magnetic attraction force acting on the mover 202, and then, the mover 202 is finally stopped. At this time, since a force acts on the mover 202 in the direction of the fixed core 207 by the second spring 212, a rebounding displacement amount can be reduced and a time until the rebounding is converged can be shortened. When the rebounding operation is small, a time for a gap is formed between the mover 202 and the fixed core 207 is shortened, and thus, a stable operation can be performed even in a smaller injection pulse width.

In this way, the mover 202 and the valve 214 after the valve-opening operation is finished are stopped in the valve-opened state. In the valve-opened state, a gap (an example of a space) is formed between the valve 214 and the valve seat 218, and the fuel is injected from the injection hole 219 into the combustion chambers 107. The fuel flows in a downstream direction (the injection hole 219) after passing through the center hole (through-hole) provided in the fixed core 207, the fuel passage hole provided in the mover 202, and the fuel passage hole provided in the guide member 215.

Thereafter, when the energization to the solenoid 205 is blocked, the magnetic flux generated in the magnetic circuit disappears, and the magnetic attraction force acting on the mover 202 also disappears. As the magnetic attraction force acting on the mover 202 disappears, the valve 214 is pressed back to a closed position in which the valve 214 comes into contact with the valve seat 218 by a force generated by the load of the first spring 210 and the fuel pressure.

### Drive Circuit of Control Device

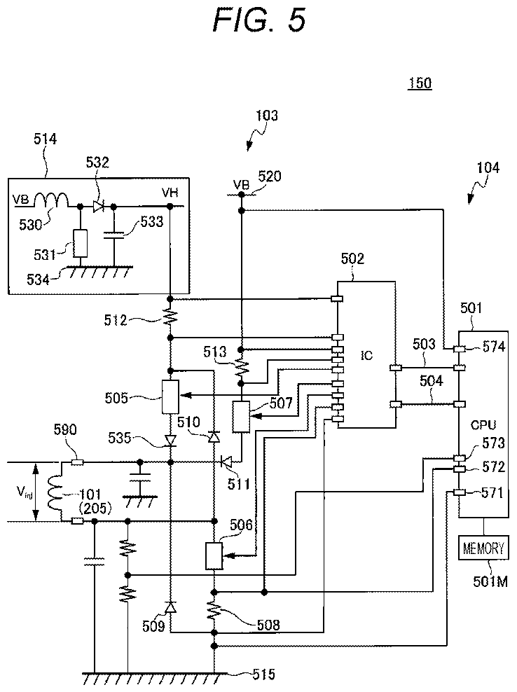

Next, a configuration of the control device 150 of the fuel injection device 101 will be described with reference to FIG. 5.

FIG. 5 is a diagram showing an example of the drive circuit 103 and the ECU 104 of the fuel injection device 101.

The control device 150 includes the drive circuit 103 and the ECU 104. For example, a drive integrated circuit (IC) 502 and a central processing unit (CPU) 501 as an arithmetic processing device are incorporated in the ECU 104. The CPU 501 (an example of a control unit) receives signals indicating a state of the engine, which are output from various types of sensors such as an A/F sensor, an oxygen sensor, and a crank angle sensor (not illustrated), in addition to the pressure sensor 102. A combination of the CPU 501 and the drive IC 502 can be referred to as a control unit. Note that the ECU 104 may include the drive circuit 103.

The fuel pipe 105 provided on the upstream of the fuel injection device 101 is attached to the pressure sensor 102 (see FIG. 1). The A/F sensor measures the amount of air flowing into the cylinder 108 (engine cylinder). The oxygen sensor detects an oxygen concentration in an exhaust gas discharged from the cylinder 108. The CPU 501 calculates the pulse width of the injection pulse (injection pulse width Ti) or the injection timing to control the injection quantity of the fuel injected from the fuel injection device 101 according to the operation condition of the internal combustion engine based on the signals received from various types of sensors.

In addition, the CPU 501 calculates a value of an appropriate injection pulse width Ti (that is, the injection quantity) or the injection timing according to the operation condition of the internal combustion engine, and outputs the injection pulse width Ti to the drive IC 502 of the fuel injection device 101 through a communication line 504. Thereafter, switching elements 505, 506, and 507 are switched between energization and de-energization by the drive IC 502 to supply the drive current to the fuel injection device 101 (solenoid 205). The switching elements 505, 506, and 507 are configured by, for example, FETs and transistors, and can switch energization and de-energization to the fuel injection device 101.

The ECU 104 is mounted with a register and a memory 501M (an example of a recording medium) which store numerical data required for controlling the engine, such as calculation of the fuel pulse width. The register and the memory 501M are included in the control device 150 or the CPU 501 in the control device 150. In the example of FIG. 5, the memory 501M is disposed outside the CPU 501. A computer program may be stored in the memory 501M to allow the CPU 501 to control the drive of the fuel injection device 101. In this case, the CPU 501 reads and executes the computer program recorded in the memory 501M to implement the entire or partial function for controlling the drive of the fuel injection device 101. Note that another arithmetic processing device such as a micro processing unit (MPU) may be used instead of the CPU 501.

The switching element 505 is connected between a boosting circuit 514 (high voltage source) that supplies a boost voltage VH and a terminal on a high voltage side of the solenoid 205 of the fuel injection device 101 (a power source side terminal 590). The boost voltage VH output from the boosting circuit 514 is higher than a battery voltage VB supplied to the drive circuit 103 from a battery voltage source 520 (low voltage source). For example, the boost voltage VH which is an initial voltage output from the boosting circuit 514 is 60 V, and the boost voltage VH is generated by boosting the battery voltage VB by the boosting circuit 514.

Examples of a method of implementing the boosting circuit 514 can include a method of configuring a boosting circuit by a DC/DC converter or the like, and a method of configuring a boosting circuit by a solenoid 530, a transistor 531, a diode 532, and a capacitor 533 as illustrated in FIG. 5. In the case of the boosting circuit 514 configured by the latter method, when the transistor 531 is turned on, a current due to the battery voltage VB flows to a ground potential 534 through the solenoid 530. On the other hand, when the transistor 531 is turned off, a high voltage generated in the solenoid 530 is rectified through the diode 532 and electric charges are accumulated in the capacitor 533. The transistor 531 is repeatedly turned on and off, such that the voltage of the capacitor 533 can be increased up to the boost voltage VH. The transistor 531 is connected to the drive IC 502 or the CPU 501, and the boost voltage VH output from the boosting circuit 514 can thus be detected by the drive IC 502 or the CPU 501.

In addition, a diode 535 is provided between the power source side terminal 590 of the solenoid 205 and the switching element 505 to allow the current to flow from the boosting circuit 514 (high voltage source) toward the solenoid 205 and the ground potential 515. In addition, a diode 511 is provided between the power source side terminal 590 of the solenoid 205 and the switching element 507 to allow the current to flow from the battery voltage source 520 (low voltage source) toward the solenoid 205 and the ground potential 515. The current does not flow from the ground potential 515 toward the solenoid 205, the battery voltage source 520, and the boosting circuit 514 during energization of the switching element 506.

In addition, the switching element 507 is connected between the battery voltage source 520 which is the low voltage source and the power source side terminal 590 of the fuel injection device 101. The value of the battery voltage VB output from the battery voltage source 520 is, for example, 12 V to about 14 V. The switching element 506 is connected between the terminal on the low voltage side of the fuel injection device 101 and the ground potential 515. The drive IC 502 detects a current value flowing to the fuel injection device 101 (each section of the drive circuit 103) by each of current detection resistors 508, 512, and 513. The drive circuit 103 generates a desired drive current by switching the energization and de-energization of the switching elements 505, 506, and 507 by the current value detected by the drive IC 502.

Diodes 509 and 510 are provided to apply a reverse voltage to the solenoid 205 of the fuel injection device 101 and to rapidly decrease the current supplied to the solenoid 205. The CPU 501 communicates with the drive IC 502 through a communication line 503, and can switch the drive current generated by the drive IC 502 according to the fuel pressure to be supplied to the fuel injection device 101 or the operation condition. In addition, both ends of each of the resistors 508, 512, and 513 are connected to an A/D conversion port of the drive IC 502, and thus, the drive IC 502 can detect the voltage applied to the both ends of each of the resistors 508, 512, and 513.

### General Timing Chart

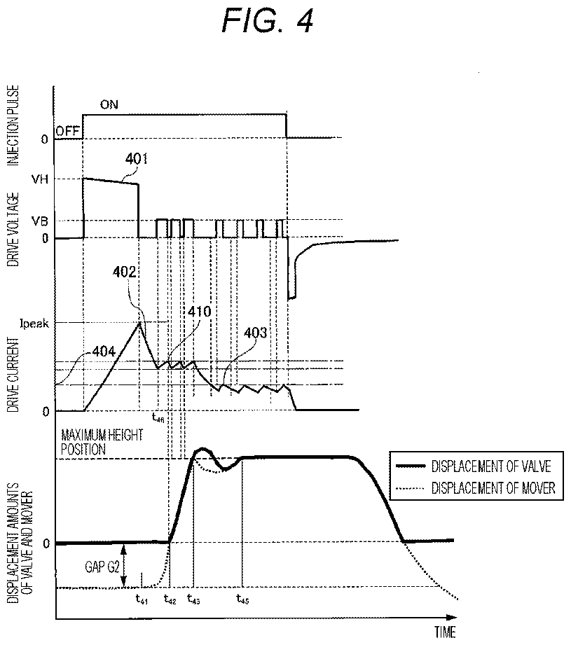

Next, a relationship between the fuel pulse output from the ECU 104, the drive voltage and the drive current (excitation current) of the both ends of the terminal of the solenoid 205 of the fuel injection device 101, and the displacement amount (valve behavior) of the valve 214 of the fuel injection device 101 will be described with reference to FIG. 4. FIG. 4 is a timing chart showing a relationship between a general injection pulse for driving the fuel injection device 101, the drive voltage and the drive current supplied to the fuel injection device 101, and displacement amounts of the valve 214 and the mover 202, and the time.

When the injection pulse is input to the drive circuit 103, the drive circuit 103 energizes the switching elements 505 and 506 according to the pulse width. Therefore, the drive circuit 103 applies a high voltage 401 to the solenoid 205 by the boosting voltage VH boosted to a voltage higher than the battery voltage VB, and starts to supply the drive current to the solenoid 205. When the current value of the current supplied to the solenoid 205 reaches a maximum drive current Iₚₑₐₖ (hereinafter, referred to as a “maximum current”) preset in the ECU 104, the drive circuit 103 stops to apply the high voltage 401.

When the switching element 506 is turned on during a period of shifting from the maximum current Iₚₑₐₖ to a predetermined current 403 and the switching elements 505 and 507 are de-energized, a voltage of almost 0 V is applied to the solenoid 205. The current supplied to the solenoid 205 flows through a route of the fuel injection device 101, the switching element 506, the resistor 508, the ground potential 515, and the fuel injection device 101, such that the current flowing to the solenoid 205 smoothly is decreased. The current flowing to the solenoid 205 smoothly is decreased, such that the current supplied to the solenoid 205 can be secured. Therefore, even in a case where the fuel pressure supplied to the fuel injection device 101 is increased, the fuel injection device 101 can stably perform the valve-opening operation until the mover 202 and the valve 214 reach maximum height positions.

The current 403 is a holding current for holding the mover 202 at the maximum height position. The maximum height position is a position (G1=0) at which the mover 202 comes into contact with the fixed core 207.

On the contrary, when the switching elements 505, 506, and 507 are turned off during a period of shifting from the maximum current Iₚₑₐₖ to the current 403, the diode 509 and the diode 510 are energized by a counter electromotive force by an inductance of the fuel injection device 101. When the diode 509 and the diode 510 are energized, the current of the solenoid 205 is fed back to the boosting circuit 514, and the current supplied to the fuel injection device 101 rapidly is decreased from the maximum current Iₚₑₐₖ as the current 402. As a result, the time for the current flowing to the solenoid 205 to reach a level of the current 403 is shortened. Therefore, when the switching elements 505, 506, and 507 are turned off, it is possible to effectively shorten the time for the magnetic attraction force to be constant after a predetermined delay time elapses from the time when the current flowing to the solenoid 205 reaches the current 403.

Then, when the current flowing to the solenoid 205 is smaller than a current value 404 (almost the same level as the current 403) required for holding the valve 214 at the maximum height position, the drive circuit 103 energizes and de-energizes the switching element 507 while energizing the switching element 506. Therefore, the battery voltage VB is applied to the solenoid 205 to maintain the level of the current 403. A switching period is set to control such a predetermined current 403 to be maintained.

In FIG. 4, during the period of shifting from the maximum current Iₚₑₐₖ to the current 403, after the drive current is decreased to the level of a current 410 at the timing t₄₆, a switching period for performing control so that the current 410 is maintained may be provided, but a switching period for maintaining the current 410 may not be provided.

When the fuel pressure supplied to the fuel injection device 101 becomes large, a fluid force acting on the valve 214 is increased, and the time for the valve 214 to reach a target opening degree becomes long due to fluid resistance. As a result, a timing when the valve 214 reaches the target opening degree with respect to a reaching time of the set maximum current Iₚₑₐₖ may be delayed. However, when the current of the solenoid 205 rapidly is decreased, the magnetic attraction force acting on the mover 202 also rapidly is decreased. Therefore, the behavior of the valve 214 becomes unstable and the valve may be closed regardless of energization in some cases. In a case where the current is smoothly decreased by energizing the switching element 506 during a period of shifting from the maximum current Iₚₑₐₖ to the current 403, the reduction of the magnetic attraction force can be suppressed, and the stability of the valve 214 at a high fuel pressure can be secured.

With such a profile of the drive current supplied to the solenoid 205, the fuel injection device 101 is driven. Between the time when the application of the high voltage 401 starts and the time when the current of the solenoid 205 reaches the maximum current Iₚₑₐₖ, the mover 202 starts to be displaced at the timing t₄₁, and the valve 214 stars to be displaced at the timing t₄₂ (G2=0). Thereafter, the mover 202 and the valve 214 reach the maximum height positions (maximum lift positions).

At the timing t₄₃ when the mover 202 reaches the maximum height position, the mover 202 collides with the fixed core 207, and the mover 202 performs a bound operation between the mover 202 and the fixed core 207. The valve 214 is configured to be displaced relative to the mover 202. Therefore, the valve 214 is separated from the mover 202, and the displacement of the valve 214 overshoots beyond the maximum height position. That is, the lower end surface of the stepped portion 329 of the valve 214 is separated from the bottom surface 202D of the concave portion 202C formed in the mover 202.

Thereafter, due to the magnetic attraction force generated by the current 403 and the force of the second spring 212 in the valve-opening direction, the mover 202 is stopped at a predetermined maximum height position. In addition, the valve 214 is seated in the mover 202 and is stopped at a position corresponding to the maximum height position, and thus, the valve 214 is in the valve-opened state (timing t₄₅).

Note that in a case of the fuel injection device having a movable valve in which the valve 214 and the mover 202 are integrated, the displacement amount of the valve 214 does not become larger than the maximum height position, and the displacement amounts of the mover 202 and the valve 214 after reaching the maximum height positions are equal to each other.

### Fuel Injection Control Method of Control Device

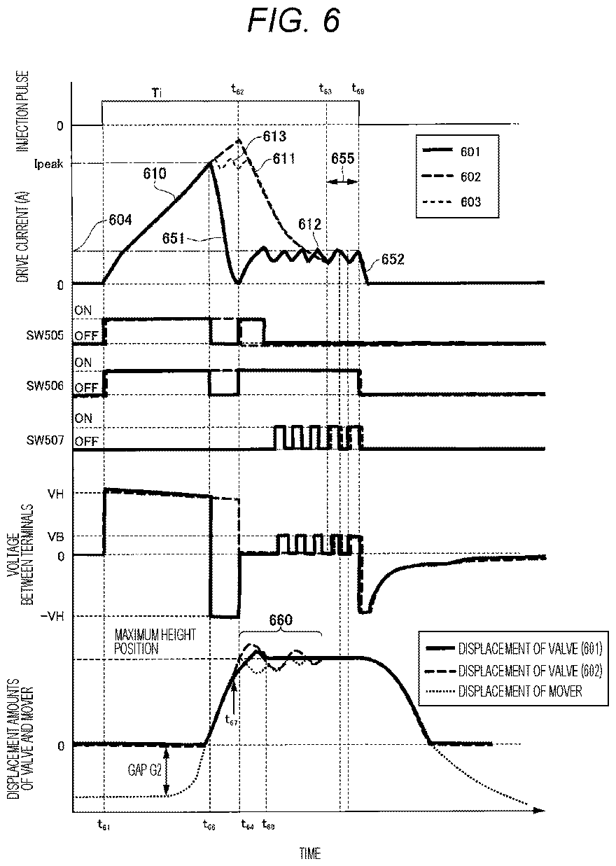

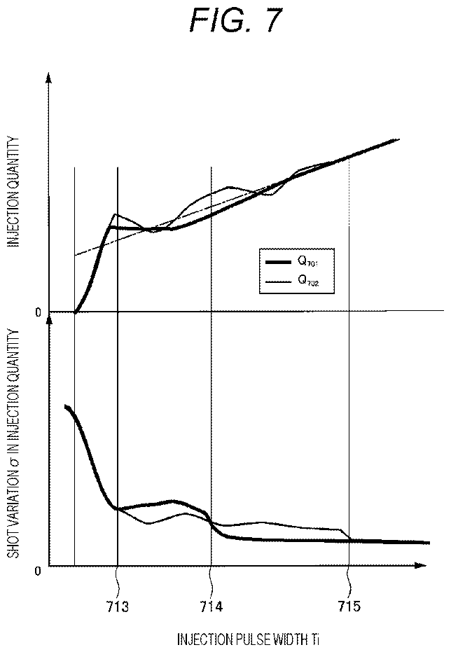

Next, a fuel injection control method of the control device 150 for controlling the fuel injection device 101 according to the first embodiment will be described with reference to FIGS. 6 and 7.

FIG. 6 is a timing chart showing a relationship between the injection pulse, the drive current supplied to the fuel injection device 101, an operation timing of the switching element of the fuel injection device 101, a voltage Vinj across terminals of the solenoid 205, and the displacement amounts of the valve 214 and the mover 202, and the time, according to the first embodiment of the present invention. In FIG. 6, the drive current, the behavior of the switching element, the voltage Vᵢₙⱼ across terminals, and the displacement amount of the valve 214 in a case using a first current waveform 601 are indicated by thick lines, and the drive current, the behavior of the switching element, the voltage Vᵢₙⱼ across terminals, and the displacement amount of the valve 214 in a case using a second current waveform 602 are indicated by thin lines. The displacement amount of the mover 202 in the case using the second current waveform 602 is indicated by a dotted line. In addition, the switching element is denoted by “SW”.

FIG. 7 illustrates a relationship between an injection quantity when the fuel injection device 101 is controlled by the drive current waveform of FIG. 6 and a standard deviation (σ) of a shot variation in injection quantity, and an injection pulse width. In FIG. 7, a characteristic of an injection quantity when the fuel injection device 101 is controlled using the first current waveform 601 is indicated by a thick line Q701, and a characteristic of an injection quantity when the fuel injection device 101 is controlled using the second current waveform 602 is indicated by a thin line Q702.

### (Second Current Control)

First, an operation of the fuel injection device 101 when the fuel injection device is controlled using the second current waveform 602 will be described.

As illustrated in FIG. 6, when the injection pulse in the injection pulse width Ti is input to the drive IC 502 through the communication line 504 at the timing t₆₁ by the CPU 501, the switching element 505 and the switching element 506 are turned on, and the boosting voltage VH higher than the battery voltage VB is applied to the solenoid 205. By doing so, the drive current is supplied to the fuel injection device 101 to rapidly raise the current as a current 610. When the current is supplied to the solenoid 205, the magnetic attraction force acts between the mover 202 and the fixed core 207. The mover 202 starts to be displaced at a timing when a resultant force of the magnetic attraction force, which is a force in the valve-opening direction, and the load of the second spring 212 exceeds the load of the third spring 234, which is a force in the valve-closing direction. Thereafter, the mover 202 runs in the gap G2, and then, the mover 202 collides with the valve 214 (G2=0). Therefore, the valve 214 starts to be displaced (valve-opening operation), and the fuel is injected from the fuel injection device 101.

Then, when the current reaches the maximum current (maximum value) at the timing t₆₂, the switching element 506 is energized, and the switching element 505 and the switching element 507 are de-energized. In this case, it becomes a so-called free wheel state in which the current is regenerated between the ground potential 515, the switching element 506, the fuel injection device 101, and the ground potential 515. A voltage of almost 0 V is applied to the both ends of the solenoid 205 of the fuel injection device 101 by the free wheel, and thus, the current is smoothly decreased as a current 611.

Thereafter, when the time reaches the timing t₆₃, the drive IC 502 switches energization and de-energization of the switching element 507 to control the current so that a current value 604 or the current value close to the current value 604 is maintained. Note that the period for controlling the current to be the current value 604 is referred to as a first current holding period 655. For example, the time to reach the timing t₆₃ may be determined using the current value obtained by adding a value preset by the ECU 104 to the value of the current 612 until the value reaches a value obtained by adding 0.1 ampere from the value of the current 612 (holding current).

The CPU 501 may perform the control to supply, to the solenoid 205, the current of the current value higher than the current value 604 capable of holding the valve 214 at the maximum height position until the timing t₆₄ (≥t₆₂) when the valve 214 reaches the maximum height position. In the example of FIG. 6, the current value of the current is higher than the current value 604 in a section from the timing t₆₆ to the timing t₆₄.

Under a condition in which the valve 214 is at a height position lower than the maximum height position, the gap (gap G1) is formed between the mover 202 and the fixed core 207. Therefore, the magnetic resistance is increased, and the magnetic attraction force is reduced, as compared to the case where the mover 202 comes into contact with the fixed core 207. Therefore, a drive current of a current value higher than the current value 604 is supplied to the solenoid 205 until the mover 202 or the valve 214 reaches the maximum height position. By doing so, the valve 214 can stably reach the maximum height position, and the timing when the valve 214 reaches the maximum height position is shortened.

As such, in the second current control using the second current waveform 602, the behavior of the valve 214 before reaching the maximum height position is stabilized, and a variation in displacement of the valve 214 for each shot is suppressed. Therefore, a shot variation σ in injection quantity after an injection pulse width 713 (see FIG. 7) in which the valve 214 reaches the maximum height position can be reduced.

Furthermore, in the example of FIG. 6, the boost voltage VH is applied to the solenoid 205, such that the current is increased beyond the maximum current Iₚₑₐₖ of the first current waveform 601. As such, a large drive current is supplied to the solenoid 205, such that the behavior of the valve 214 before reaching the maximum height position is further stabilized.

On the other hand, since the mover 202 collides with the fixed core 207 at a high speed, the mover 202 bounces between the mover 202 and the fixed core 207 or the valve 214 as shown in a section 660. As a result, there is a problem in that the shot variation σ in injection quantity is not reduced even after the injection pulse width 713. The problem also occurs in the case of the current waveform illustrated in FIG. 4. That is, such a problem may occur under the condition in which the current of the high current value is supplied to the solenoid 205 until the valve 214 reaches the maximum height position.

### (First Current Control)

A drive method in the first current control using the first current waveform 601 as a method for solving the problem, and a relationship between the injection quantity (injection pulse width) and the shot variation in injection quantity will be described. As indicated by the thick line in FIG. 6, the CPU 501 controls the voltage applied to the solenoid 205 so that the drive current of the first current waveform 601 is supplied to the solenoid 205. The first current waveform 601 is a waveform in which a current reaches the maximum current Iₚₑₐₖ before the mover 202 collides with the fixed core 207 and the current is decreased from the maximum current Iₚₑₐₖ before the mover 202 collides with the fixed core 207.

As illustrated in FIG. 6, in order to suppress a speed at which the mover 202 collides with the fixed core 207, the mover 202 starts to be displaced in the direction of the fixed core 207, and the switching elements 505, 506, and 507 are turned off at the timing t₆₆ when the mover 202 is sufficiently accelerated. As a result, the diode 509 and the diode 510 are energized by a counter electromotive force generated in the solenoid 205 of the fuel injection device 101. Therefore, the current is fed back to the boosting circuit 514, and the current supplied to the fuel injection device 101 rapidly is decreased from the maximum current Iₚₑₐₖ as a current 651. In this case, a reverse polarity voltage (−VH) with a magnitude corresponding to the boost voltage VH is generated as a counter electromotive force across the terminals of the solenoid 205.

When the reverse voltage is applied to the solenoid 205 to rapidly decrease the current, after a constant delay due to an eddy current, a magnetic flux generated in the magnetic circuit is reduced, and the magnetic attraction force acting on the mover 202 is reduced. Thereafter, the mover 202 and the valve 214 are decelerated at the timing t₆₇, and the speed at which the mover 202 collides with the fixed core 207 is decreased.

As a result, the bounding generated between the mover 202 and the fixed core 207 and the valve 214 is decreased, and the timing when the bounding of the valve 214 is converged is shortened to the timing t₆₈. Therefore, the shot variation σ in injection quantity after an injection pulse width 714 (see FIG. 7) after the valve 214 reaches the maximum height position and a certain time has elapsed can be reduced than in the case using the second current waveform 602. In addition, in the case using the first current waveform 601, the speed at which the mover 202 collides with the fixed core 207 is reduced. Therefore, a driving sound generated from the fuel injection device 101 can be reduced as compared to the case using the second current waveform 602.

On the other hand, in the case using the first current waveform 601, since the mover 202 and the valve 214 are decelerated before the valve 214 reaches the maximum height position, the behavior of the valve 214 before the valve 214 reaches the maximum height position may be unstable. For example, the shot variation in injection quantity under a condition in which the injection pulse width is smaller than the injection pulse width 714 may be larger than in the case using the second current waveform 602.

Therefore, as described above, in the first embodiment, the current control for the solenoid 205 is switched based on the injection quantity of the fuel (injection pulse width for injecting the injection quantity) to be injected until the valve 214 comes into contact with the valve seat 218 again after the valve 214 is separated from the valve seat 218, the injection quantity being calculated by the CPU 501 of the control device 150.

That is, in a case where a small injection quantity less than the injection quantity in the injection pulse width 714 (an example of a set value) is required, the CPU 501 performs the second current control for the solenoid 205 by the second current waveform 602 until the mover 202 collides with the fixed core 207 so that a current larger than the current 612 (holding current) capable of holding the mover 202 in a state of being into contact with the fixed core 207 flows to the solenoid 205. In addition, in a case where an injection quantity larger than the injection quantity (set value) in the injection pulse width 714 is required, the CPU 501 performs the first current control for the solenoid 205 by the first current waveform 601 by switching a polarity of a voltage applied to the solenoid 205 before the mover 202 collides with the fixed core 207 to a polarity reverse to the polarity of the voltage applied before the mover 202 collides with the fixed core 207.

As such, in the present embodiment, the current control for the solenoid 205 is performed by switching the first current waveform and the second current waveform according to the injection quantity of the fuel injected in the valve-opened state (injection pulse width), such that the variation in displacement of the valve 214 for each shot can be suppressed in a range from the small injection quantity to the large injection quantity. Therefore, the shot variation in injection quantity of the fuel injection device 101 can be reduced. As a result, the fuel efficiency and the exhaust performance of the internal combustion engine such as an in-cylinder direct injection type engine are improved, resulting in a cost reduction.

Furthermore, the CPU 501 of the control device 150 may perform the second current control using the second current waveform 602 so that the voltage applied to the solenoid 205 after the mover 202 collides with the fixed core 207 is lowered to the set voltage at which the holding current (current 612) flows. The voltage and current applied to the solenoid 205 are controlled, such that the valve 214 can stably reach the maximum height position. In the present embodiment, as can be appreciated from FIG. 6, the polarity of the set voltage in the second current control is the same as the polarity of the voltage before the polarity of the set voltage is reversed in the first current control by the first current waveform 601 (positive polarity in FIG. 6).

In addition, when the current higher than the current 612 (holding current) is applied to the mover 202, the valve 214 can stably reach the maximum height position. Therefore, in the case using the second current waveform 602, the timing when the maximum current Iₚₑₐₖ is stopped may not necessarily be set after the valve 214 reaches the maximum height position and may be set before the valve 214 reaches the maximum height position.

In addition, in the case using the second current waveform 602, even in a case where any one of the first current waveform 601 and the second current waveform 602 is used in the injection pulse width lager than the injection pulse width 715, the shot variation in injection quantity is the same as in the case where the bounding of the valve 214 is sufficiently converged at the timing when the injection pulse is stopped. In this case, for example, when the fuel pressure of the fuel pipe 105 through which the fuel is supplied to the fuel injection device 101 is high, the CPU 501 uses the second current waveform 602 so that the valve 214 stably reaches the maximum height position. On the other hand, when it is required to reduce the driving sound of the fuel injection device 101 caused by a low rotational speed of the engine such as a warm idle condition, the CPU 501 uses the first current waveform 601.

As such, when there is a command for the injection pulse width larger than the preset injection pulse width 715, the CPU 501 may perform the control to switch the current waveform of the drive current according to the operation condition.

In the case using the first current waveform 601, when the reverse voltage is applied to the solenoid 205 after the current reaches the maximum current Iₚₑₐₖ, the boost voltage VH may be applied to the solenoid 205. The current cannot be increased due to the counter electromotive force caused by the displacement of the mover 202 while the valve 214 is displaced. However, the applied voltage is increased, such that the current can certainly reach the current 612 (holding current), and the valve 214 can be stably held in the valve-opened state.

As described above, in the present embodiment, the current waveform in which the shot variation in injection quantity can be reduced is appropriately set according to the injection quantity (or the injection pulse width). Therefore, it is possible to suppress the shot variation in injection quantity from the small injection quantity to the large injection quantity, that is, over the entire region from a region in which the load of the engine is small to a region in which the load of the engine is large.

For example, the shot variation in injection quantity is suppressed, such that in the case using exhaust gas recirculation (EGR) for performing lean combustion in which the fuel is leaner than that in the theoretical air-fuel ratio or circulating the exhaust gas to the intake side in order to improve the fuel efficiency, even under a condition in which a combustion speed becomes slow, the same combustion state can be realized for each injection and the combustion stability can be improved. The present embodiment is suitable to be applied to the fuel injection control of the internal combustion engine which requires high accuracy of the injection quantity, such as when the injection quantity in the combustion cycle is very small.

In addition, in the first current waveform 601 and the second current waveform 602, when the injection pulse is stopped at the timing t₆₉, all the switching elements 505, 506, and 507 are de-energized. Then, the diode 509 and the diode 510 are energized by the counter electromotive force by the inductance of the fuel injection device 101, the current is fed back to the boosting circuit 514, the current supplied to the fuel injection device 101 rapidly is decreased as the current 652 and thus reaches 0 A. Then, when the supply of the current is stopped, the magnetic attraction force acting on the mover 202 is reduced, and the valve 214 starts to be closed from a position lower than the maximum height position at the timing when the force in the valve-opening direction, which is a resultant force of the magnetic attraction force, the load of the second spring 212, and the inertia force of the mover 202, is less than the force in the valve-closing direction by the load of the first spring 210 and the differential pressure acting on the valve 214. Then, the valve 214 comes into contact with the valve seat 218 at the timing t₆₄, and the injection of the fuel is stopped.

In the first embodiment described above, in the first current control using the first current waveform 601, the voltage applied to the solenoid 205 before the mover 202 collides with the fixed core 207 is positive, but may be negative. The same is applied to each of the following embodiments. In the first current control, the polarity of the voltage applied to the solenoid 205 may be reversed before and after the mover 202 collides with the fixed core 207. The polarity of the voltage applied before the mover 202 collides with the fixed core 207 may be appropriately selected according to displacement directions of the mover 202 and the valve 214 and the configuration of the drive circuit 103. As such, according to the present invention, it is possible to flexibly design the displacement directions of the mover 202 and the valve 214, the configuration of the drive circuit 103, and the polarity of the voltage applied.

### First Modification of First Embodiment

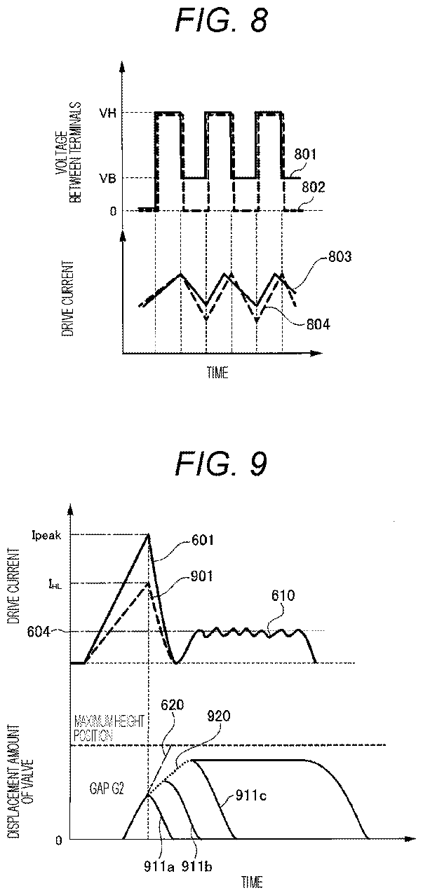

Next, a first modification of the first embodiment of the present invention will be described with reference to FIG. 8. FIG. 8 is a diagram showing a relationship between the voltage across terminals of the solenoid 205 and the drive current supplied to the fuel injection device, and the time, according to the first modification of the first embodiment of the present invention.

In the first embodiment, in the case where the second current waveform 602 is used, it is required to supply a large current value until the valve 214 reaches the maximum height position. Therefore, the maximum current Iₚₑₐₖ supplied to the solenoid 205 becomes large. In this case, since heat generated by the fuel injection device 101 and the ECU 104 is increased in proportion to the square of the supply current, the heat generation may be problematic, which may limit the current applied to the solenoid 205.

On the contrary, as illustrated in FIG. 8, in the second current control, a current waveform 603 (third current waveform) in which a maximum current Iₚₑₐₖ (current 613) is maintained may be used by repeating the application of the boosting voltage VH and the application of the battery voltage VB after the drive current reaches the maximum current Iₚₑₐₖ. The CPU 501 controls the voltage applied to the solenoid 205 by turning on and off the switching elements 505 and 507, such that the current waveform 603 may become a waveform in which the current reaches the maximum current Iₚₑₐₖ before the mover 202 collides with the fixed core 207 and the maximum current Iₚₑₐₖ is maintained even after the mover 202 collides with the fixed core 207. In FIG. 6, the maximum current Iₚₑₐₖ is maintained for a predetermined time even after the timing t₆₄ when the mover 202 collides with the fixed core 207. The voltage application to the solenoid 205 may be realized by repeating the application of the boost voltage VH and the application of the voltage of 0 V.

In FIG. 8, the voltage across the terminals by the repetition of the application of the boost voltage VH and the application of the battery voltage VB is indicated by a solid line 801, and the drive current at this time is indicated by a solid line 803. In addition, the voltage across the terminals by the repetition of the application of the boost voltage VH and the application of the voltage of 0 V is indicated by a broken line 802, and the drive current at this time is indicated by a broken line 804. In the repetition of the application of the boost voltage VH and the application of the battery voltage VB (solid line 801), a fluctuation of the voltage across the terminals is smaller than in the repetition of the application of the boost voltage VH and the application of the voltage of 0 V (broken line 802), and thus, the behavior of the valve 214 is stable.

As such, the current waveform 603 is used in the second current control, such that it is possible to secure a current required until the valve 214 reaches the maximum height position without increasing the value of the maximum current Iₚₑₐₖ. Therefore, the heat generation of the ECU 104 is suppressed and the variation in displacement of the valve 214 for each shot is suppressed by the second current control using the current waveform 603.

### Second Embodiment

Next, a fuel injection control method of the control device 150 for controlling the fuel injection device 101 according to a second embodiment of the present invention will be described with reference to FIG. 9. FIG. 9 is a diagram showing a relationship between the drive current supplied to the fuel injection device 101 and the displacement amount of the valve, and the time, according to the second embodiment of the present invention.

In a case where an injection quantity smaller than the injection quantity when the valve 214 is closed after reaching the maximum height position, it is preferable to perform half-lift control for driving the valve 214 in a half-lift state where the valve 214 does not reach the maximum height position. However, in the half-lift state, the displacement amount of the valve 214 is not restricted by a stopper (for example, the fixed core 207). Therefore, the displacement amount of the valve 214 may vary due to a slight change in force. Since the magnetic attraction force is strongly influenced by the magnetic resistance, as a distance between the mover 202 and the fixed core 207 becomes smaller, the magnetic resistance is reduced, and the magnetic attraction force is increased. In addition, the magnetic attraction force does not momentarily become zero due to the influence of the eddy current even when the injection pulse is stopped and the current flowing to the solenoid 205 is 0 A, and the magnetic attraction force is reduced over time. However, when the magnetic attraction force is too strong, the valve 214 may reach the maximum height position even when the ECU 104 stops the output of the injection pulse.

On the contrary, in a case where the half-lift control that starts the movement of the mover 202 in the valve-closing direction is performed before the mover 202 collides with the fixed core 207, the control using the first current waveform 601 may be performed as illustrated in FIG. 6. The CPU 501 performs the control so that the reverse voltage is applied to the solenoid 205 after the mover 202 is accelerated, and the mover 202 reaches the maximum height position by the current 610. Therefore, it is possible to control the injection quantity in the half-lift state while suppressing a rapid increase in the magnetic attraction force acting on the mover 202.

In addition, in the case where the half-lift control is performed, it is not necessary to supply energy to allow the valve 214 to reach the maximum height position. Therefore, the maximum current at the time of the half-lift control may be smaller than that in the case using the first current waveform 601.

In FIG. 9, a current waveform 901 indicated by a broken line is an example of the current waveform at the time of the half-lift control. In the current waveform 901 at the time of the half-lift control, a maximum current I_{HL} which is a maximum value may be smaller than the maximum current Iₚₑₐₖ of the first current waveform 601. In the current waveform 901, the maximum current I_{HL} is smaller than the maximum current Iₚₑₐₖ. Therefore, a slope 920 of the displacement of the valve 214 according to the current waveform 901 is smaller than a slope 620 of the displacement of the valve 214 according to the first current waveform 601. Therefore, it is possible to control the injection quantity in the half-lift state while suppressing the rapid increase in the magnetic attraction force. Each of displacements 911a, 911b, and 911c represents a change in displacement amount when the moving direction of the valve 214 is switched from the valve-opening direction to the valve-closing direction at each point of the current waveform 901.

### Third Embodiment

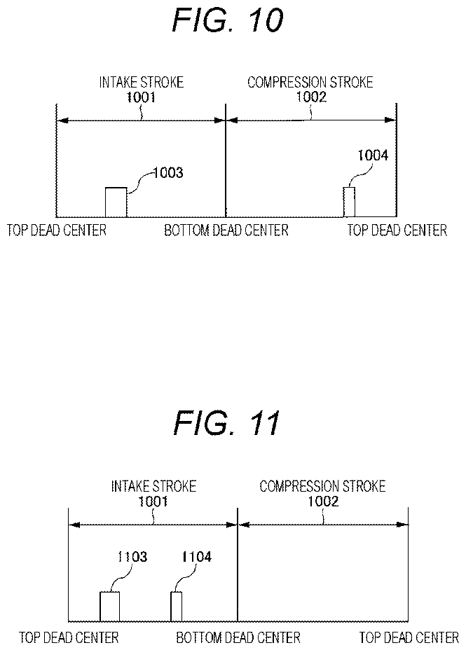

Next, a fuel injection control method of the control device 150 for controlling the fuel injection device 101 according to a third embodiment of the present invention will be described with reference to FIGS. 1, 5 and 6, and 10. FIG. 10 illustrates an injection timing and an injection period of each of an intake stroke and a compression stroke when performing a split injection during one combustion cycle.

In the fuel injection control method according to the third embodiment, in order to form a homogeneous air mixture in the cylinder 108, a first injection 1003 is carried out in an intake stroke 1001, which is the timing when the flow in the cylinder 108 is strong, to inject a large injection quantity of the fuel. Then, in order to form a rich air mixture by which the fuel more easily ignite around an ignition plug than air, in the compression stroke 1002, it is preferable to carry out a second injection 1004 in which the injection time is shorter than in the injection 1003 to inject a small injection quantity of the fuel required for one combustion cycle. In the present specification, a state of the air mixture in which a larger amount of fuel is contained than that in the theoretical air-fuel ratio is referred to as “rich”.

In this case, since the injection quantity in the injection 1004 is smaller than that in the injection 1003, the injection 1003 of the intake stroke 1001 is carried out using the first current waveform 601 according to the first embodiment (see FIG. 6), and the injection 1004 of the compression stroke 1002 is carried out using the second current waveform 602 (or the current waveform 603) according to the first embodiment (see FIG. 6). The shot variation in injection quantity is suppressed by performing such a fuel injection control, such that a variation in homogeneity in the intake stroke 1001 is suppressed. Furthermore, a variation in air mixture formed around the ignition plug in the compression stroke 1002 is suppressed, and combustion stability is improved.

In particular, under a condition in which a three-way catalyst is activated at the time of starting the engine, the ignition timing may be retarded (delayed) from a top dead center to increase a loss of the exhaust gas, thereby controlling the temperature of the catalyst to be increased. In a case where the ignition timing is retarded, the combustion becomes unstable. Therefore, the injection control that ensures the combustion stability is effective by injecting the fuel in the latter half of the compression stroke 1002 and forming a rich air mixture around the ignition plug. In this case, the fuel injected in the compression stroke 1002 blows during the one combustion cycle to be 40% or less of the injection quantity. That is, a large amount of the fuel may be injected in the intake stroke 1001 to form a homogeneous air mixture, and a smaller amount of the fuel than in the intake stroke 1001 may be injected in the compression stroke 1002 to form a rich air mixture around the ignition plug.

In the fuel injection control method according to the third embodiment as described above, the injection 1003 of the intake stroke 1001 is carried out using the first current waveform 601 according to the first embodiment, and the injection in the compression stroke 1002 is carried out using the second current waveform 602 (or the current waveform 603) according to the first embodiment. As such, the CPU 501 of the control device 150 may be controlled to perform each of the first current control for the solenoid 205 using the first current waveform 601 and the second current control using the second current waveform 602 (or the current waveform 603) for the solenoid 205 at least once during one combustion cycle.

According to such a fuel injection control method, the shot variation in injection quantity in each of the intake stroke 1001 and the compression stroke 1002 can be suppressed.

### Fourth Embodiment

Next, a fuel injection control method of the control device 150 for controlling the fuel injection device 101 according to a fourth embodiment will be described with reference to FIGS. 1, 5 and 6, and 11. FIG. 11 illustrates an injection timing and an injection period of each of an intake stroke and a compression stroke when performing a split injection during one combustion cycle. In FIG. 11, the same reference numerals are used for the same configurations as in FIG. 10.

In the fuel injection control method according to the fourth embodiment, in order to form a homogeneous air mixture in the cylinder 108, a first injection 1103 is carried out at the timing when the flow in the intake stroke 1001 is strong, and a large injection quantity of the fuel is injected. Thereafter, a second injection 1104 with an injection quantity smaller than in the injection 1103 is carried out at the timing when the flow is reduced.

In general, since injections subsequent the second injection are carried out to finely adjust the injection quantity, the injection quantity is small. Therefore, since the injection quantity in the second injection 1104 is smaller than that in the first injection 1103, the injection 1103 of the intake stroke 1001 is carried out using the first current waveform 601 according to the first embodiment, and the subsequent injection 1104 is carried out using the second current waveform 602 (or the current waveform 603) according to the first embodiment. As such, the CPU 501 of the control device 150 may be controlled to perform each of the first current waveform 601 and the second current waveform for the solenoid 205 at least once during one combustion cycle.

According to such a fuel injection control method, the shot variation in injection quantity is suppressed. Therefore, the variation in homogeneity in the intake stroke 1001 is suppressed, and the combustion stability is improved.

### Modification of Fourth Embodiment

Furthermore, when two or more injections are carried out during the combustion cycle, in a case where the injection quantity of the fuel injected from the fuel injection device 101 at one time is equal to or less than a threshold value preset (set value) in the ECU 104, the CPU 501 mounted in the ECU 104 of the control device 150 may perform current control so that the number of times of performing the second current control using the second current waveform 602 (or the current waveform 603) is larger than the number of times of performing the first current control using the first current waveform 601.

Performing of the fuel injection control corresponds to the case where an injection of a minute amount of fuel is required, which is the case where in which two or more injections are carried out during the combustion cycle. That is, even in the case where the injection of a minute amount of fuel is required, the shot variation in injection quantity in the combustion cycle is suppressed.

### Fifth Embodiment

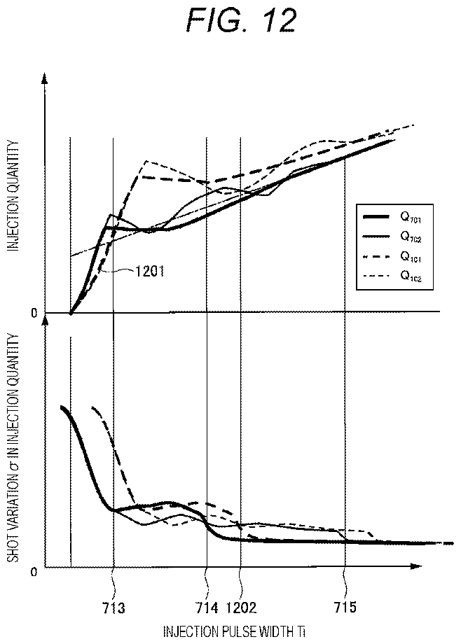

Next, a fuel injection control method of the control device 150 for controlling the fuel injection device 101 according to a fifth embodiment will be described with reference to FIGS. 1, 5, and 12. FIG. 12 illustrates a relationship between an injection quantity and a standard deviation (σ) of a shot variation in injection quantity, and an injection pulse width, according to the fifth embodiment of the present invention. In FIG. 12, in the case where the fuel pressure is not higher than in the first embodiment, an injection quantity and a shot variation in injection quantity when the first current waveform 601 is used are indicated by a thick broken line Q101, and an injection quantity and a shot variation in injection quantity when the second current waveform 602 (or the current waveform 603) is used are indicated by a fine broken line Q102.

In a control method of the fuel injection device 101 according to the fifth embodiment, the control device 150 may set an injection quantity of the fuel injected (injection pulse width) until the valve 214 comes into contact with the valve seat 218 again after the valve 214 is separated from the valve seat 218 to a lager value, as the fuel pressure is higher.

As illustrated in FIG. 12, when the pressure of the fuel supplied to the fuel injection device 101 is high, a fluid force is increased due to the fuel pressure acting on the valve 214. Therefore, a slope of a characteristic of the injection quantity becomes small as in an injection quantity 1201, and the injection pulse width for the valve 214 to reach the maximum height position becomes large. Accordingly, the injection pulse width 714 in which a magnitude relationship between the shot variations in injection quantities in the first current waveform 601 and the second current waveform 602 (or the current waveform 603) is switched is increased up to an injection pulse width 1202. In addition, even in the same displace amount of the valve 214, the higher the fuel pressure, the larger the injection quantity to be injected.

Therefore, in the present embodiment, the CPU 501 sets a larger set value of the injection quantity (or the injection pulse width) from the opening of the valve 214 to the closing of the valve 214 as the fuel pressure is higher, the set value being set to switch between the first current waveform 601 and the second current waveform 602. Therefore, it is possible to stably reduce the shot variation in injection quantity even in a case where the fuel pressure is changed. In other words, in the present embodiment, robustness (strong property against disturbance) of the fuel injection control in the case where the fuel pressure is changed can be ensured.

In addition, when the fuel pressure is increased and the fluid force acting on the valve 214 thus is increased, a speed of the mover 202 may be reduced, and a collision speed when the mover 202 collides with the fixed core 207 may be reduced. In this case, even when the timing t₆₆ when the maximum current Iₚₑₐₖ of the first current waveform 601 is stopped is delayed, the bounding of the valve 214 after the valve 214 reaches the maximum height position can be suppressed. Therefore, the current may be controlled so that the timing when the maximum current Iₚₑₐₖ is stopped is delayed as the fuel pressure is higher. That is, the CPU 501 performs a control so that the timing when the voltage applied to the solenoid 205 is switched to less than 0 V (reverse polarity) by the first current control is delayed, as the fuel pressure is higher.

As such, the timing when the maximum current Iₚₑₐₖ is stopped is changed according to the fuel pressure, such that it is possible to achieve both the stability to allow the valve 214 to reach the maximum height position and the reduction of the shot variation in injection quantity by the reduction of the bounding of the valve 214.

### Others

Further, the present invention is not limited to the above-described embodiments, and various other applications and modifications may be made without departing from the scope of the present invention described in the claims.

For example, in the above-described embodiments, the configurations of the fuel injection system 1 and the control device 150 are described in detail and specifically in order to clearly explain the present invention, and the present invention is not necessarily limited to including all the described constituent elements. In addition, a part of the configuration of an embodiment can be replaced with a constituent element of another embodiment. In addition, a constituent element of an embodiment can be added to a configuration of another embodiment. In addition, a part of the configuration of each embodiment can be subjected to addition, deletion, or replacement of other constituent elements.

For example, in each of the above-described first to fifth embodiments, the fuel injection device 101 is configured to have an internal structure in which the mover 202 attracted by the magnetic attraction force collides with the fixed core 207, but the present invention is not limited to this configuration. A movable portion (for example, the mover 202, the valve 214, or the like) pulled up by the magnetic attraction force in the valve-opening direction may collide (come into contact) with an arbitrary fixed portion disposed or formed inside the fuel injection device 101. The fixed core 207 is an example of the fixed portion. Alternatively, the fuel injection device 101 may be configured not to use the intermediate member 220 (gap forming member). Even with these configurations, similar to the configurations of the above-described first to fifth embodiments, when the current waveform of the drive current supplied to the solenoid 205 is appropriately set according to the injection quantity (or the injection pulse width), the shot variation in injection quantity can be suppressed.

In addition, each of the above configurations, functions, processing units, and the like may be realized by hardware by designing some or all of them as, for example, an integrated circuit. In addition, each of the above constituent elements, functions, and the like may be realized by software in which a processor interprets and executes a program for realizing the respective functions. Information about programs, tables, files, and the like for realizing the respective functions can be stored in a recording device such as a semiconductor memory, hard disk, or a solid-state drive (SSD) or a magnetic or optical recording medium.

In addition, control lines or information lines which are considered to be necessary for the explanation are described in the above embodiments, but the control lines or the information lines in the product may not necessarily be entirely described. Practically, it may be assumed that almost all constituent elements are connected to each other.

### REFERENCE SIGNS LIST

101, 101A-101D fuel injection device
103 drive circuit
104 ECU
107 fuel chamber
108 cylinder
150 control device
202 mover
205 solenoid
207 fixed core
214 valve
218 valve seat
219 injection hole
501 CPU
501M memory
601 first current waveform
602 second current waveform
610 current (holding current)
714 injection pulse width (set value)

1. A control device for a vehicle for controlling a fuel injection device including a valve which comes into contact with and is separated from a valve seat, a mover which drives the valve, a solenoid which generates a magnetic attraction force for attracting the mover to form a space for introducing a fuel between the valve seat and the valve, and a fixed core which attracts the mover by the magnetic attraction force, the control device comprising a control unit that performs:
a first current control for the solenoid by a first current waveform by switching a polarity of a voltage applied to the solenoid before the mover or the valve collides with a fixed portion to a polarity reverse to the polarity of the voltage applied before the mover or the valve collides with the fixed portion, when an injection quantity of the fuel injected until the valve comes into contact with the valve seat again after the valve is separated from the valve seat is a set value or more; and
a second current control for the solenoid by a second current waveform so that a current larger than a holding current holding the mover or the valve in a state of being in contact with the fixed portion flows to the solenoid, until the mover or the valve collides with the fixed portion, when the injection quantity of the fuel injected until the valve comes into contact with the valve seat again after the valve is separated from the valve seat is less than the set value.

2. The control device for a vehicle according to claim 1, wherein the control unit performs the second current control by lowering a voltage applied to the solenoid after the mover or the valve collides with the fixed portion to a set voltage at which the holding current flows.

3. The control device for a vehicle according to claim 2, wherein a polarity of the set voltage in the second current control is the same as the polarity of the voltage before being reversed in the first current control.

4. The control device for a vehicle according to claim 1, wherein the control unit controls the voltage applied to the solenoid in the first current control so that a current reaches a maximum current before the mover or the valve collides with the fixed portion and the current is decreased from the maximum current before the mover or the valve collides with the fixed portion.

5. The control device for a vehicle according to claim 1, wherein the control unit controls the voltage applied to the solenoid in the second current control so that a current reaches a maximum current before the mover or the valve collides with the fixed portion, and the maximum current is maintained even after the mover or the valve collides with the fixed portion.

6. The control device for a vehicle according to claim 1, wherein the control unit performs each of the first current control and the second current control for the solenoid at least once during one combustion cycle.

7. The control device for a vehicle according to claim 6, wherein in an intake stroke, the control unit performs the first current control in a first injection and performs the second current control in a subsequent injection.

8. The control device for a vehicle according to claim 7, wherein the control unit performs the second current control in a compression stroke.

9. The control device for a vehicle according to claim 1, wherein in a case where two or more injections are carried out during one combustion cycle, when the injection quantity of the fuel injected from the fuel injection device at one time is equal to or less than a set threshold value, the control unit performs a control so that the number of times of performing the second current control is larger than the number of times of performing the first current control.

10. The control device for a vehicle according to claim 1, wherein the set value of the injection quantity of the fuel injected until the valve comes into contact with the valve seat again after the valve is separated from the valve seat is larger as a fuel pressure is higher.

11. The control device for a vehicle according to claim 1, wherein the control unit performs a control so that a timing when the polarity of the voltage applied to the solenoid is reversed by the first current control is delayed as a fuel pressure is higher.

12. The control device for a vehicle according to claim 1, wherein in a case where a half-lift control that starts a movement of the mover or the valve in a valve-closing direction is performed before the mover or the valve collides with the fixed portion, the control unit performs the first current control.

13. The control device for a vehicle according to claim 1, wherein the injection quantity of the fuel injected is determined based on an injection pulse width of the fuel injection device which injects the fuel introduced into the space.

14. The control device for a vehicle according to claim 1, wherein the fixed portion is the fixed core.

15. A fuel injection control method for a vehicle for controlling a fuel injection device including a valve which comes into contact with and is separated from a valve seat, a mover which drives the valve, a solenoid which generates a magnetic attraction force for attracting the mover to form a space for introducing a fuel between the valve seat and the valve, and a fixed core which attracts the mover by the magnetic attraction force, the fuel injection control method comprising processes of performing:
a first current control for the solenoid by a first current waveform by switching a polarity of a voltage applied to the solenoid before the mover or the valve collides with a fixed portion to a polarity reverse to the polarity of the voltage applied before the mover or the valve collides with the fixed portion, when an injection quantity of the fuel injected until the valve comes into contact with the valve seat again after the valve is separated from the valve seat is a set value or more; and
a second current control for the solenoid by a second current waveform so that a current larger than a holding current holding the mover or the valve in a state of being in contact with the fixed portion flows to the solenoid, until the mover or the valve collides with the fixed portion, when the injection quantity of the fuel injected until the valve comes into contact with the valve seat again after the valve is separated from the valve seat is less than the set value.

16. A fuel injection control program for a vehicle allowing a computer to execute processes of performing:
a first current control for a solenoid by a first current waveform by switching a polarity of a voltage applied to the solenoid before a mover or a valve collides with a fixed portion to a polarity reverse to the polarity of the voltage applied before the mover or the valve collides with the fixed portion, when an injection quantity of the fuel injected until the valve comes into contact with a valve seat again after the valve is separated from the valve seat is a set value or more; and
a second current control for the solenoid by a second current waveform so that a current larger than a holding current holding the mover or the valve in a state of being in contact with the fixed portion flows to the solenoid, until the mover or the valve collides with the fixed portion, when the injection quantity of the fuel injected until the valve comes into contact with the valve seat again after the valve is separated from the valve seat is less than the set value,
the computer being included in a control device for a vehicle for controlling a fuel injection device including the valve which comes into contact with and is separated from the valve seat, the mover which drives the valve, the solenoid which generates a magnetic attraction force for attracting the mover to form a space for introducing a fuel between the valve seat and the valve, and a fixed core which attracts the mover by the magnetic attraction force.
